(19) United States
(12) Patent Application Publication
(10) Pub. No.: US 2007/0290603 A1
(43) Pub. Date: Dec. 20, 2007

(54) Display Apparatus

(75) Inventors: Atsuo Ishizuka, Kanagawa (JP); Yoshiaki Sakamoto, Kanagawa (JP); Hisashi Yamaguchi, Kanagawa (JP)

Correspondence Address: BIRCH STEWART KOLASCH & BIRCH, PO BOX 747, FALLS CHURCH, VA, 22040-0747, US

(73) Assignee: Fuju Photo Film Co., Ltd., Minami--Ashigara-shi (JP)

(21) Appl. No.: 10/594,737

(22) PCT Filed: Mar. 14, 2005
(86) PCT No.: PCT/JP05/04471

§ 371 Date: Jul. 9, 2007

(30) Foreign Application Priority Data
Mar. 31, 2004 (JP) JP04/004670

(51) Int. Cl. H01J 1/62

(52) U.S. Cl. 313/498

(57) ABSTRACT

A display apparatus which comprises: a substrate; a first electrode group made up of a plurality of electrode patterns which are arranged adjacent to one another on said substrate, and extend in a first extending direction; a second electrode group made up of a plurality of electrode patterns which are arranged adjacent to one another on said substrate, and extend in a second extending direction which is different from said first extending direction; and a plurality of display elements which are each formed in correspondence to the intersection point of one electrode pattern among said first electrode group and one electrode pattern among said second electrode group, wherein at least said first electrode group includes a plurality of electrode patterns which are each connected to a drive circuit at one end, and are different in length from said one end to the other end, each of said plurality of electrode patterns has a lamination structure which has a first conductor having a first sheet resistivity, and a second conductor having a second sheet resistivity lower than said first sheet resistivity; each of said plurality of electrode patterns is provided with a higher resistance region where said second conductor is removed, and the length of said higher resistance region is changed according to the length of said electrode pattern for each of said plurality of electrode patterns.

### TECHNICAL FIELD

The present invention generally pertains to a display apparatus, and particularly relates to a display apparatus which uses a luminescence device of current drive type.

### BACKGROUND ART

The conventional display apparatus is mainly constituted by a liquid crystal display apparatus, however, in recent years, the display apparatus constituted by a plasma display apparatus has begun to be used. Further, it is performed to use an organic EL display apparatus for constitution of a display apparatus.

In order to provide such a display apparatus at low cost, it is preferable to use a drive configuration of passive matrix type. By using a passive matrix drive configuration, the thin film transistor which is required for active matrix drive configuration can be omitted.

FIG. 1 shows a schematic configuration of a display apparatus 10 having such a passive matrix drive configuration.

Referring to FIG. 1, the display apparatus 10 comprises a display substrate 11 in which a display region 11A is formed, and on said substrate 11, a number of scanning lines 11a and data lines 11b extend in the X direction and the Y direction, respectively.

Further, to said substrate 11, a drive circuit 12A which selectively drives one of said scanning lines 11a, and a drive circuit 12B which selectively drives one or more than one of said data lines 11b are connected.

Then, by selecting one scanning line 11a with said drive circuit 12A, and selecting one data line 11b or a plurality of data lines 11b with said drive circuit 12B, one pixel or a plurality of pixels corresponding to the intersection point(s) between said selected scanning line 11a and data line(s) 11b emits light or emit light simultaneously.

Generally, said drive circuit 12A, 12B is formed in the shape of an integrated circuit chip, and it is typically connected to said display substrate 11 with a flexible substrate on which wiring patterns are printed for rendering the display apparatus compact. Such a form of packaging is known as a chip-on-film (COM) packaging. Especially when the COF packaging technology is used to package a drive circuit, ITO (In₂O₃.SnO₂) patterns, which are suited for compression bonding of the flexible substrate, are often used.

### DISCLOSURE OF THE INVENTION

### Problems to be Solved by the Invention

The inventor of the present invention has discovered that, particularly in driving a display apparatus of current drive type, such as an organic EL device, a plasma display apparatus, or the like, if the length of the wiring pattern for connecting the drive circuit to the scanning line or the data line is changed for each line, there occurs a problem that the drive is rendered non-uniform.

FIGS. 2 and 3 shows the configuration of a connection part 11C between the drive circuit 12A and the scanning line 11a in the display apparatus 10 in FIG. 1.

Referring to FIG. 2, 3, said connection part 11C is constituted by ITO wiring patterns 11c which are connected to the scanning lines 11a made up of Al, however, it can be seen that the pitch of said ITO wiring patterns 11c on the side where they are connected to said drive circuit 12A is reduced, as compared to the pitch on the side for connection to said display region 11A, in order to be matched to the electrode pitch for the drive circuit. In FIG. 2, in said connection part 11C, said ITO wiring patterns 11c are linearly extended, which results in the pattern spacing between said ITO wiring patterns 11c being changed from that on the side where they are connected to the drive circuit 12A to that on the side the display region, while, in FIG. 3, said pattern spacing is maintained at a constant value.

In either of the cases as shown in FIG. 2 and FIG. 3, the length of said ITO wiring pattern 11c in said connection part 11C is changed depending upon the portion between the substrate middle and the substrate peripheral ones, and it is unavoidable that the length in the substrate peripheral portion is longer than that in the substrate middle portion. With this, in said connection part 11C, the resistance for the ITO wiring pattern 11c is changed depending upon the portion between the substrate middle and the substrate peripheral ones, and with this, the luminescence intensity can also be changed depending upon the portion between the substrate middle and the substrate peripheral ones.

For example, assuming that the sheet resistivity of the ITO wiring pattern 11c constituting the leader part of said scanning line 11a is 10Ω/□, and said ITO wiring pattern 11c has a wiring length of 5 mm, and a wiring width of 50 μm, the wiring resistance thereof is 1 kΩ, and if the drive current is 10 mA, a voltage drop reaching 10 V is caused along the ITO wiring pattern 11c.

In a configuration as shown in FIG. 2 or 3 in which, in addition to such a voltage drop, the pitch of the ITO wiring patterns 11c is changed in the connection part 11C, and thus the length of the ITO wiring pattern 11c constituting the scanning line 11a is changed between the substrate middle portion and the peripheral portion, it is unavoidable that the wiring resistance for the ITO wiring pattern 11c is at minimum with the scanning line 11a in the substrate middle portion, while the wiring resistance for the ITO wiring pattern 11c is at maximum with the scanning line 11a at the upper and lower ends. Then, for example, if; as said ITO wiring pattern 11c, an ITO wiring pattern having a sheet resistivity of 10Ω/□ and a wiring width of 10 μm is used, and the difference in length between said ITO wiring patterns 11c in the substrate middle portion and the peripheral portion is 10 mm, a difference in drive voltage that reaches 20 V is caused between the scanning line 11a in the substrate middle portion and the scanning line 11a in the substrate peripheral portion.

In other words, as a result of the investigation by the inventor of the present invention, it has been revealed that, with the display apparatus having such a configuration, a pixel which will not be lighted even if a drive voltage of 20 V is applied is caused to occur in the peripheral portion of the display substrate 11.

Generally, the art which reduces the resistance value for the ITO pattern by laminating a lower resistance material, such as a Cr material, or the like, on the ITO pattern is well known. However, with such a method, the change in resistance resulting from the difference in length between ITO wiring patterns on the display substrate as shown in the connection part 11C in FIG. 2, 3 cannot be compensated for correspondingly to each of the ITO wiring patterns.

As a method for compensating for the change in resistance that results from the difference in length between individual ITO wiring patterns, the method which changes the pattern width in correspondence to the length of the ITO wiring pattern can be considered. For example, considering the case where the ITO wiring pattern 11c in said connection part 11C for the scanning line 11a in the middle portion among the 100 scanning lines 11a has a wiring length of 5 mm and a pattern width of 20 μm, and the wiring length of the ITO wiring pattern 11c at the substrate upper or lower end is 10 mm, increasing the width of the ITO wiring pattern 11c from said scanning line 11a in the middle portion toward the scanning line 11a at the upper or lower end to 40 μm in increments of 0.4 μm allows compensation for the change in resistance value that results from the difference in wiring length in said connection part 11C.

However, the actual ITO pattern has a tolerance for pattern width of as loose as ±1 μm or so, resulting in the deviation in resistance value being ±5% for a pattern width of 20 μm, and ±2.5% for a pattern width of 40 μm, thus it is difficult to actually carry out such a manufacturing step. In addition, such a method for adjusting the pattern width requires a tremendous number of design steps.

Patent literature 1: US Patent Publication No. 2001-050799

Patent literature 2: Japanese Patent Laid-Open Publication No. 2002-162647

Patent literature 3: Japanese Patent Laid-Open Publication No. 2002-221536

Patent literature 4: Japanese Patent Laid-Open Publication No. 62-124529

### Means to Solve the Problems

One aspect of the present invention provides a display apparatus, comprising:

a substrate;

a first electrode group made up of a plurality of electrode patterns which are arranged adjacent to one another on said substrate, and extend in a first direction;

a second electrode group made up of a plurality of electrode patterns which are arranged adjacent to one another on said substrate, and extend in a second direction which is different from said first direction; and

a plurality of display elements which are each formed in correspondence to the intersection point of one electrode pattern among said first electrode group and one electrode pattern among said second electrode group,

wherein

at least said first electrode group includes a plurality of electrode patterns which are each connected to a drive circuit at one end, and are different in length from said one end to the other end,

each of said plurality of electrode patterns has a lamination structure which has a first conductor having a first sheet resistivity, and a second conductor having a second sheet resistivity lower than said first sheet resistivity,

each of said plurality of electrode patterns is provided with a higher resistance region where said second conductor is removed, and

the length of said higher resistance region is changed according to the length of said electrode pattern for each of said plurality of electrode patterns.

### EFFECTS OF THE INVENTION

According to the present invention, even in the case where the overall length of said electrode pattern is changed for each of the electrode patterns constituting said first electrode group, and as a result of this, the resistance value for the overall length of the electrode pattern constituting said first electrode group is changed for each electrode pattern, the length of said second conductor is changed according to the overall length of said electrode pattern, whereby such a change in resistance value can be compensated for, which allows more uniform display to be realized with a display apparatus.

The other problems to be solved by the present invention and the other features of the present invention will be clarified by a detailed explanation of the present invention that will be hereinbelow given with reference to the drawings.

### BRIEF DESCRIPTION OF THE DRAWINGS

FIG. 1 is a drawing illustrating a schematic configuration of the conventional display apparatus of passive matrix drive type;

FIG. 2 is a drawing illustrating the problem to be solved by the present invention;

FIG. 3 is a drawing illustrating the problem to be solved by the present invention;

FIG. 4 is a drawing illustrating a schematic configuration of an organic EL display apparatus of passive matrix drive type according to a first embodiment of the present invention;

FIG. 5 is a sectional view illustrating a part of the organic EL display apparatus as shown in FIG. 4;

FIG. 6 is a drawing illustrating a detailed configuration of the connection part of the organic EL display apparatus as shown in FIG. 4;

FIG. 7A is a drawing illustrating a sectional structure of the connection part of the organic EL display apparatus as shown in FIG. 4;

FIG. 7B is a drawing illustrating a sectional structure of the connection part of the organic EL display apparatus as shown in FIG. 4;

FIG. 8 is a drawing illustrating a schematic configuration of an organic EL display apparatus of passive matrix drive type according to a second embodiment of the present invention;

FIG. 9 is a drawing illustrating a detailed configuration of the connection part of the organic EL display apparatus as shown in FIG. 8;

FIG. 10A is a drawing illustrating a sectional structure of the connection part of the organic EL display apparatus as shown in FIG. 8;

FIG. 10B is a drawing illustrating a sectional structure of the connection part of the organic EL display apparatus as shown in FIG. 8;

FIG. 11 is a table giving the characteristics of the organic EL display apparatus according to the present invention;

FIG. 12 is a drawing illustrating one modification of the organic EL display apparatus as shown in FIG. 6;

FIG. 13 is a drawing illustrating a part of an organic EL display apparatus of passive matrix drive type according to a third embodiment of the present invention;

FIG. 14 is a drawing illustrating a part of an organic EL display apparatus of passive matrix drive type according to a fourth embodiment of the present invention;

FIG. 15 is a drawing illustrating a part of an organic EL display apparatus of passive matrix drive type according to a fourth embodiment of the present invention; and

FIG. 16 is a drawing illustrating a part of an organic EL display apparatus of passive matrix drive type according to a fifth embodiment of the present invention.

### EXPLANATION OF REFERENCE NUMERALS AND SIGNS IN THE DRAWINGS

10, 20, 40: Organic EL display apparatus
11, 21: Substrate
11A, 21A: Display region
11C, 21C, 41C: Connection part
11a, 21a: Scanning line
11b, 21b: Data line
11c: Wiring pattern
12A, 12B, 22A, 22B: Drive circuit
20A: Hole transportation layer
20B: Luminescence layer
20C: Electron transportation layer
20D: Cathode
20E: Organic EL device
21T, 41T: Terminal part
21a₁, 41a₁: ITO pattern
21a₂, 41a₂: Cr pattern
21c: Wiring pattern

### BEST MODE FOR CARRYING OUT THE PRESENT INVENTION

### First Embodiment

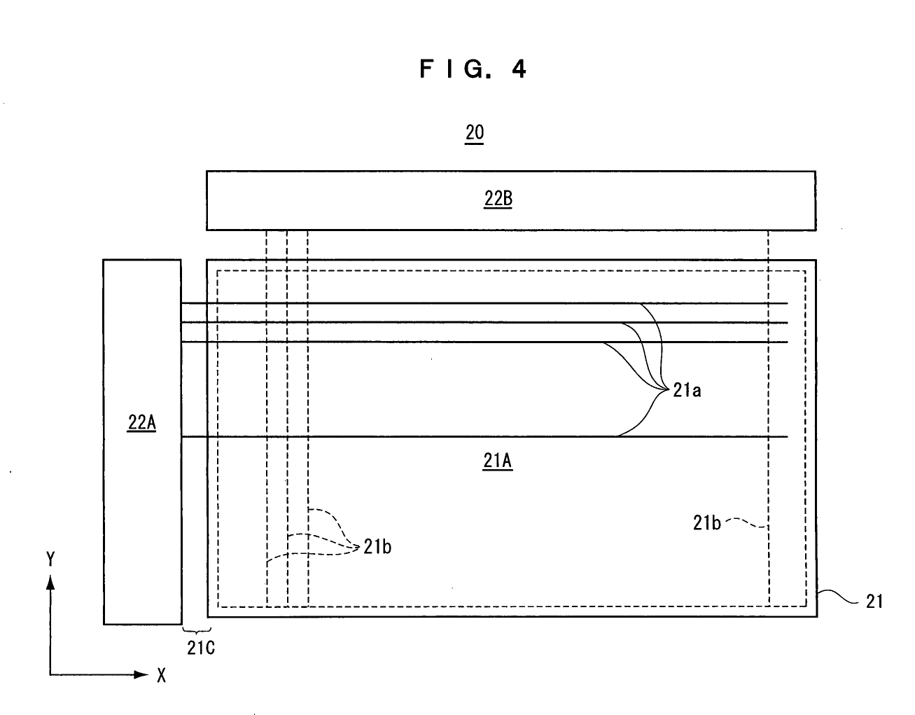

FIG. 4 shows the configuration of an organic EL display apparatus 20 of passive matrix drive type of a first embodiment of the present invention.

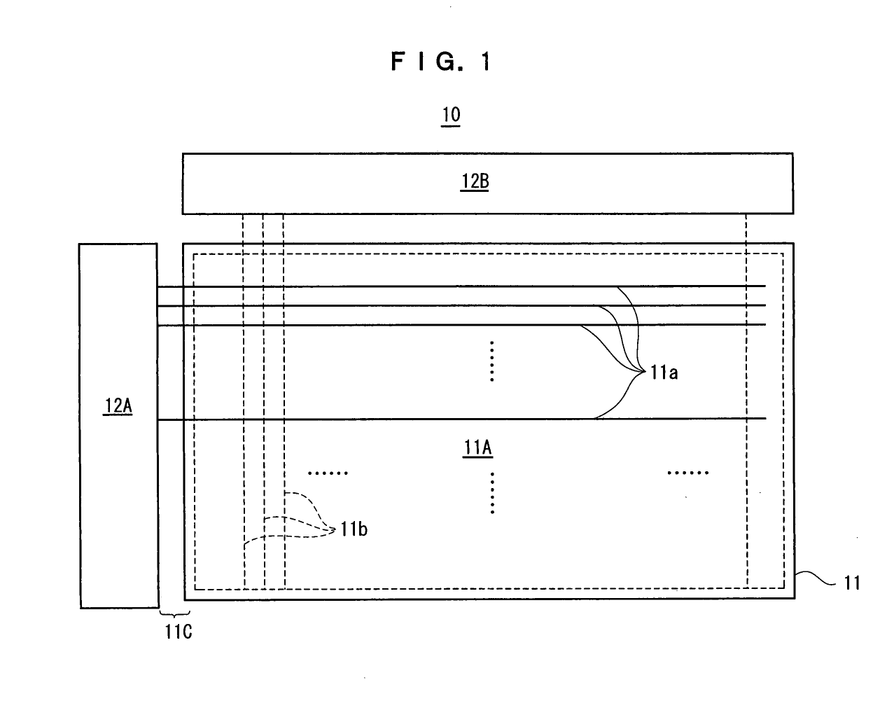

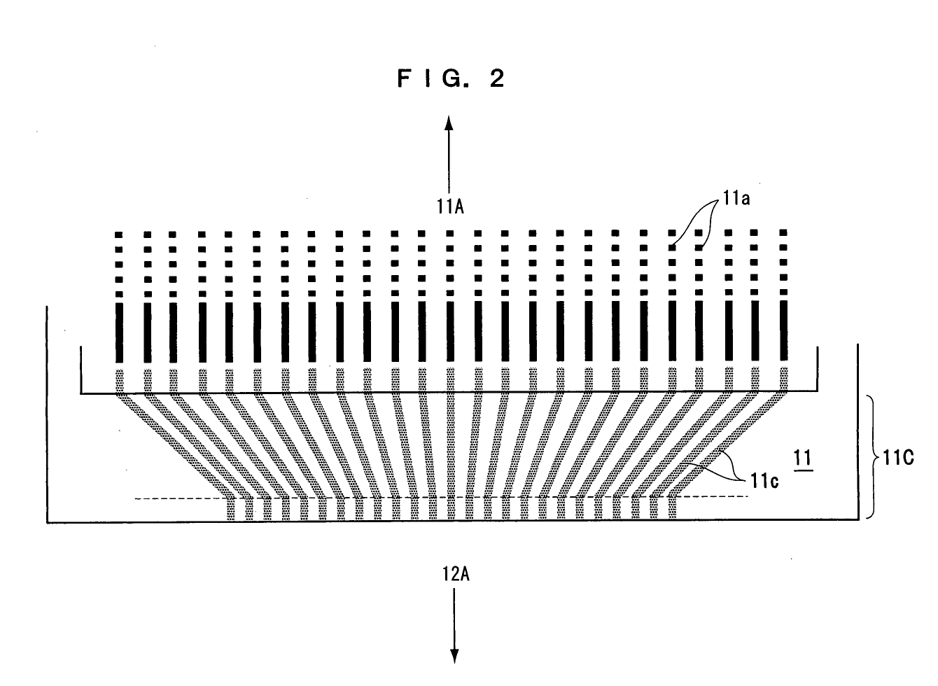

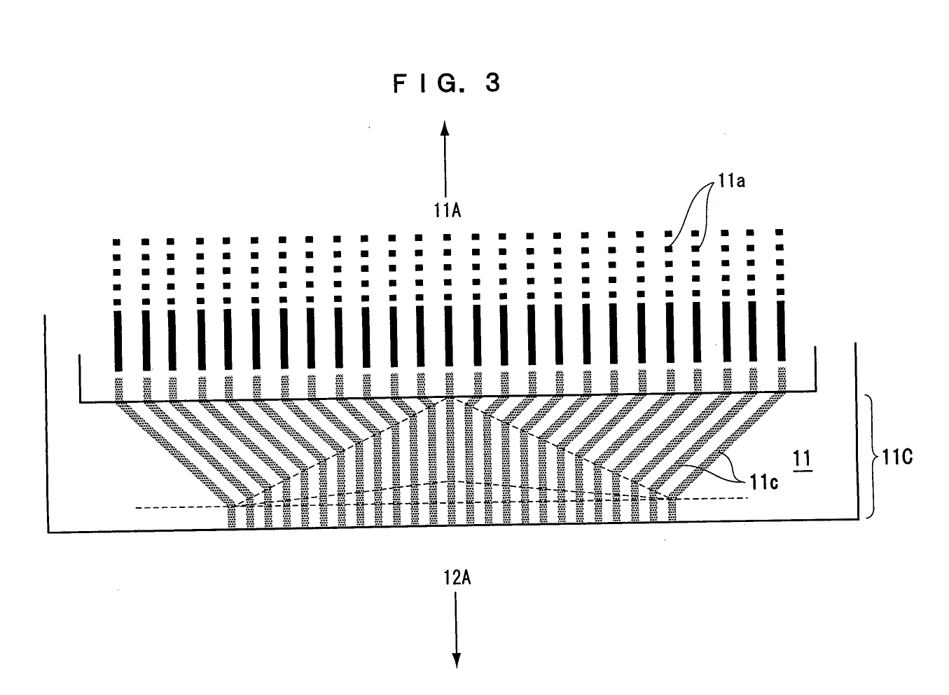

Referring to FIG. 4, the display apparatus 20 has the similar configuration as a display apparatus 10 in FIG. 1 as a whole, comprising a display substrate 21 in which a display region 21A is formed, and on said substrate 21, a number of scanning lines 21a and data lines 21b extend in the X direction and the Y direction.

Further, to said substrate 21, a drive circuit 22A which selectively drives one of said scanning lines 21a, and a drive circuit 22B which selectively drives one or more than one of said data lines 21b are connected.

Then, by selecting one scanning line 21a with said drive circuit 22A, and selecting one data line 21b or a plurality of data lines 21b with said drive circuit 22B, one pixel or a plurality of pixels corresponding to the intersection point(s) between said selected scanning line 21a and data line(s) 21b emit(s) light simultaneously.

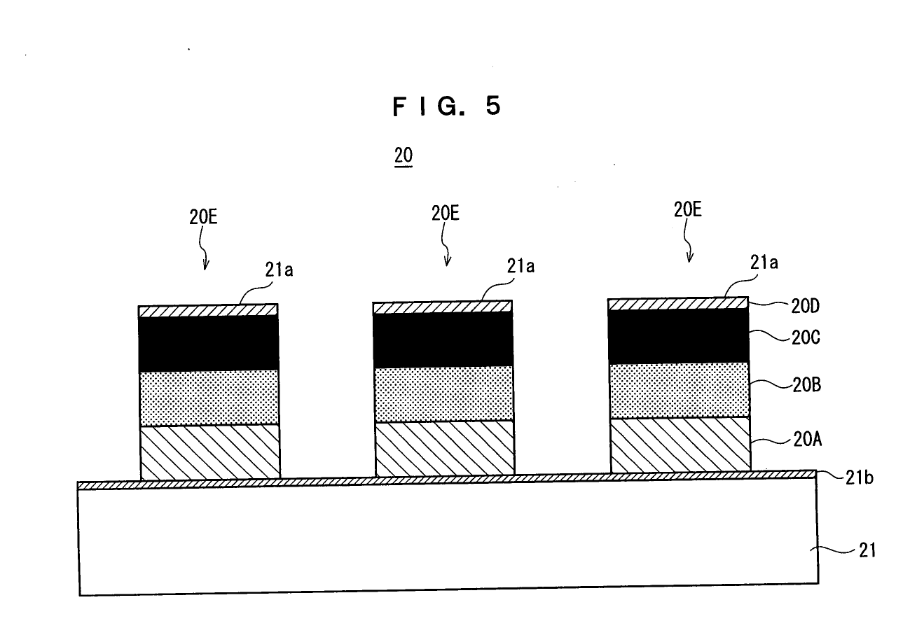

FIG. 5 shows a sectional view along the data line 21b in the display apparatus 20 in FIG. 4.

Referring to FIG. 5, said data lines 21b are patterned in parallel on the glass substrate 21, constituting the anode. On the respective data lines 21b, an organic EL device 20E in which a hole transportation layer 20A, a luminescence layer 20B, and an electron transportation layer 20C are laminated is repetitively formed typically by the vapor deposition method using a mask, and the organic EL devices 20E thus formed are arranged in the shape of a matrix on said glass substrate 21.

The space between organic EL devices 20E thus arranged in the shape of a matrix is filled with an insulating film (not shown), and further a cathode 20D made up of Al, or the like, is formed such that it connects a group of organic EL devices which are aligned in the X direction, of said organic 20E devices. Said cathode 20D constitutes the scanning line 21a in the configuration as shown in FIG. 4.

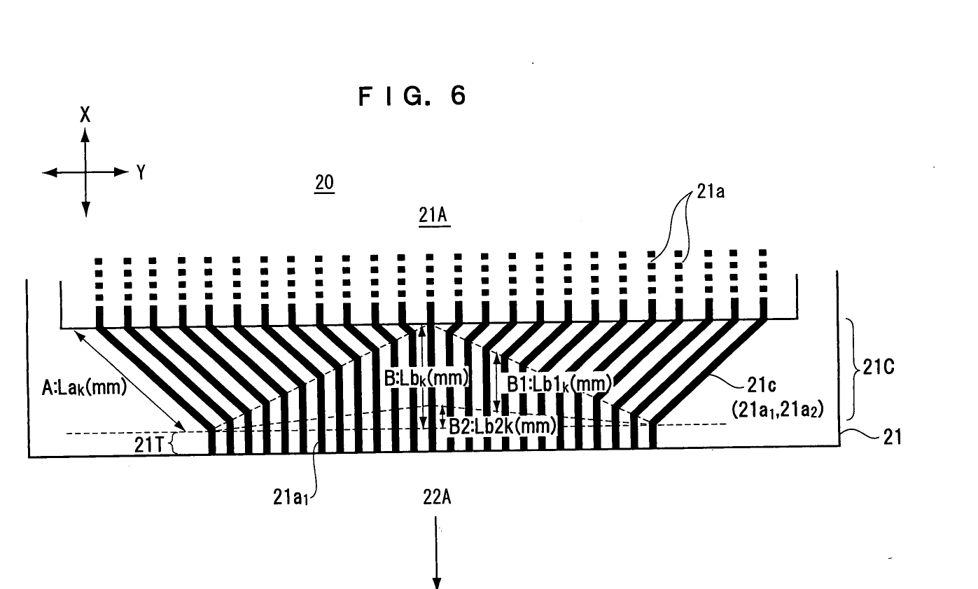

FIG. 6 shows, in detail, the configuration of a connection part 21C between said scanning lines 21a and drive circuit 22A that corresponds to a connection part 11C in FIG. 1, 2.

Referring to FIG. 6, in said connection part 21C, the repetition spacing between scanning lines 21a which extend in said display region 21A is reduced to be matched to the terminal spacing for the integrated circuit chip constituting said drive circuit 22A, and together with this, the wiring patterns 21c which extend from the ends of the scanning lines 21a which are extended in parallel in said display region 21A are flexed in said connection part 21C. As described below, said wiring pattern 21c is configured by laminating an ITO pattern 21a₁ and a Cr pattern 21a₂ with a lower resistance that is formed on said ITO pattern 21a₁.

More specifically, said connection part 21C is constituted by a segment A where the wiring pattern 21c which extends from the end of said scanning line 21a extends slantwise with respect to the extending direction (the X direction) in said display region 21A, and the segment B where said wiring pattern 21c extends back in said X direction at the end of said segment A to be continued to a terminal part 21T for connection to said drive circuit 22A, and in either of the segments A, B, the wiring patterns 21c which correspond to the different scanning lines 21a extend in parallel with one another.

In FIG. 6, said segment A is defined such that, of said plurality of wiring patterns 21c, the pattern in the middle portion that has the shortest wiring length provides a length of zero, while the pattern on the outermost side that has the longest wiring length provides a maximum length of Laₘₐₓ, and said segment B is defined such that, of said plurality of wiring patterns 21c, the pattern in the middle portion that has the shortest wiring length provides a maximum length of Lbₘₐₓ, while the pattern on the outermost side that has the longest wiring length provides a length of zero.

As a result of making such a configuration, the wiring length in said segment A linearly decreases from the wiring pattern 21c on the outermost side toward the shortest wiring pattern 21c in the middle portion, and the wiring length in the segment B linearly increases from the wiring pattern 21c on the outermost side toward the shortest wiring pattern 21c in the middle portion.

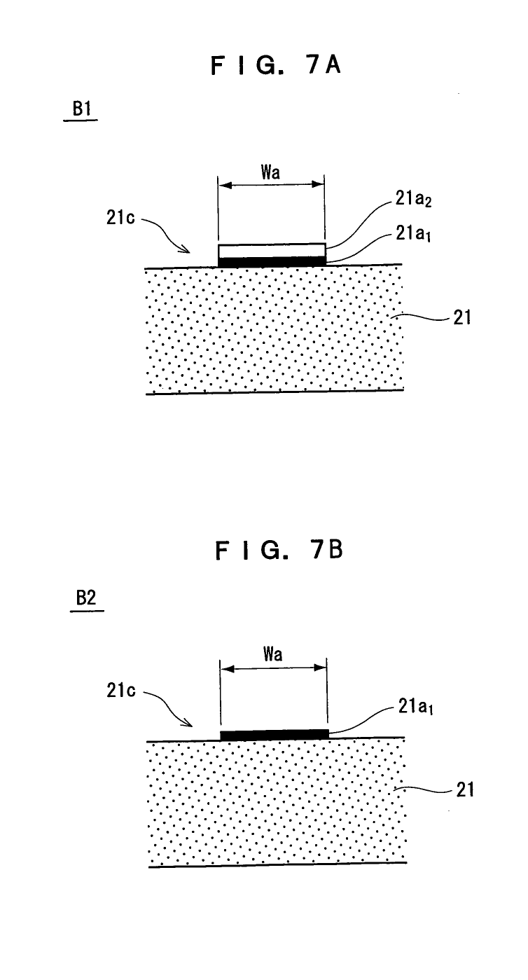

In the present embodiment, said segment B is further divided into a first segment B, and a second segment B₂, and as shown in FIG. 7A, 7B, by selectively removing said Cr film 21a₂ with a lower resistance in said second segment B₂, the length of the Cr pattern 21a₂ in the wiring pattern 21c in the segment B₁ is trimmed in order to match the resistance value for the wiring pattern 21c to a definite value. FIG. 7A shows a section of the wiring pattern 21c in said segment B₁, while FIG. 7B shows a section of the wiring pattern 21c in said segment B₂.

In this way, in the present invention, by selectively removing said Cr film 21a₂ having a lower resistance in said second segment B₂, equivalent resistance elements are inserted into said segment B₂. In this case, in the present embodiment, by adjusting the length in said segment B₂ rather than adjusting the width Wa of the pattern 21a, as shown in FIG. 7A, 7B, the resistance value for said resistance element is capable of being set with good accuracy.

Hereinbelow, the specific procedure for performing such a trimming operation will be described.

Referring back to FIG. 6, as previously stated, the length La (mm) of the segment A is zero in the middle portion of the electrode group constituting said scanning lines 21a. Then, if the length La of said wiring pattern on the outermost side in said wiring group is Laₘₐₓ (mm), the length La (Laₖ) of the wiring pattern is linearly changed between the middle portion and the outermost portion of the wiring group, and the kth wiring length Laₖ is expressed by either of the following equations:

$$\begin{matrix}{La}_{k} = - \frac{2 {La}_{max}}{n} k + {La}_{max} , ( 0 \leq k \leq \frac{n}{2} ) & [ \text{Math} 1 ] \\ \text{and} & \\ {La}_{k} = \frac{2 {La}_{max}}{n} k - {La}_{max} , ( \frac{n}{2} < k \leq n ) & [ Math 2 ]\end{matrix}$$

On the other hand, the length Lb (mm) of the segment B is also linearly changed, providing a maximum at the center of the wiring group, and zero at the outermost end of the wiring group. Then, if the Lb at the center of the wiring group is Lbₘₐₓ, the kth wiring length Lbₖ is expressed by either of the following equations:

$$\begin{matrix}{Lb}_{k} = \frac{2 {Lb}_{max}}{n} k , ( 0 \leq k \leq \frac{n}{2} ) & [ Math 3 ] \\ \text{and} & \\ {Lb}_{k} = \frac{2 {La}_{max}}{n} k - {La}_{max} , ( \frac{n}{2} < k \leq n ) & [ Math 4 ]\end{matrix}$$

In the configuration in FIG. 6, it is preferable that the portion where said Cr film 21b is provided be as said segment B, in order to avoid a reduction in mechanical strength that is caused by providing a lower resistance auxiliary wiring, such as a Cr film, for the terminal part 21T, and said Cr film 21b be formed such that it extends consecutively from said segment A.

As previously stated, the segment B is constituted by the segment B, (corresponding to FIG. 7A) where the ITO film 21a₁ and the Cr film 21a₂ are laminated, and the segment B₂ (corresponding to FIG. 7B) that provides only the ITO film 21a₁, and the length of the extending portion of each of said scanning lines 21a is designated to be Lb₁ₖ (mm) for said segment B₁, and to be Lb₂ₖ (mm) for said segment B₂.

In addition, assuming that the sheet resistivity of said ITO film 21 as is Rᵢₜₒ (Ω/□); the sheet resistivity of the Cr film 21a₂ is Rₐᵤₓ (Ω/□); and the line width for said segment A is Wa (mm); and the line width for said segment B is Wb (mm), then, the wiring resistance Raₖ, Rbₖ for said segment A, B is given by the following equations, respectively.

$${Ra}_{k} = \frac{{R}_{ito} \cdot {R}_{aux}}{{R}_{ito} + {R}_{aux}} \cdot \frac{{La}_{k}}{Wa} \\ {Rb}_{k} = \frac{{R}_{ito}}{Wb} ( \frac{{R}_{aux}}{{R}_{ito} + {R}_{aux}} Lb {1}_{k} + Lb {2}_{k} ) \qquad [ Math 5 ]$$

Then, the resistance Rₖ of the wiring in the connection part 21C that corresponds to the kth scanning line 21a is given by the following equation:
Rₖ=Raₖ+Rbₖ

Now, on the basis of the above description, the operation of providing a uniform wiring resistance (trimming) by using the Cr film 21a₂ as an auxiliary wiring pattern is discussed.

Such an operation of providing a uniform wiring resistance involves determining the value of Lb1ₖ, Lb2ₖ that always gives a constant value of Rₖ in the above equation regardless of the value of k.

Herein, for simplicity, a range of 0≦k≦n/2 is taken, then the value of Lb2ₖ for k=n/2, in other words, the pattern in the middle portion of the wiring group, i.e., the value of Lb2_{(n/2)} is expressed by the following equation from the relational expression of Lb1ₖ+Lb2ₖ=Lbₘₐₓ.

$$Lb {2}_{( n / 2 )} = \frac{{R}_{aux}}{{R}_{ito} + {R}_{aux}} \cdot \frac{Wb}{Wa} \cdot ( 1 + \frac{{R}_{aux}}{{R}_{ito}} ) \cdot {La}_{max} - \frac{{R}_{aux}}{{R}_{ito}} \cdot {Lb}_{max} \qquad [ Math 6 ]$$

Herein, the following derivation is performed.

When k=n/2, the following relational expression is obtained.

$${Rb}_{k} = \frac{{R}_{ito}}{Wb} ( \frac{{R}_{aux}}{{R}_{ito} + {R}_{aux}} ) Lb {1}_{k} + Lb {2}_{k} \qquad [ Math 7 ]$$

Herein, assuming that

$$C 1 = \frac{{R}_{ito}}{Wb} , C 2 = \frac{{R}_{aux}}{{R}_{ito} + {R}_{aux}} \qquad [ Math 8 ]$$

then, the following relational expressions are obtained.

$${Rb}_{k} = C 1 ( C 2 \cdot LB {1}_{k} + Lb {2}_{k} ) , \\ Lb {2}_{k} = \frac{{Rb}_{k}}{C 1} - C 2 \cdot Lb {1}_{k} = {Lb}_{max} - Lb {1}_{k} , \\ Lb {1}_{k} = \frac{1}{C 2 - 1} ( \frac{{Rb}_{( n / 2 )}}{C 1} - {Lb}_{max} ) , \\ Lb {2}_{k} = \frac{{Rb}_{( n / 2 )}}{C 1} - C 2 \cdot Lb {1}_{k} = \frac{{Rb}_{( n / 2 )}}{C 1} - \frac{C 2}{C 2 - 1} ( \frac{{Rb}_{( n / 2 )}}{C 1} - {Lb}_{max} ) \qquad [ Math 9 ]$$

Since the requirement that all the patterns must be equal in resistance is imposed, the value of the 0th Raₖ, i.e., Ra₍₀₎ after the trimming must be equal to that of the n/2th Rbₖ, i.e., Rb_{(n/2)}. Therefore, the following relational expression is obtained.

$${Rb}_{( n / 2 )} = {Ra}_{( 0 )} = C 1 \frac{{La}_{max}}{Wa} \cdot {R}_{ito} \qquad [ Math 10 ]$$

From this, the following relational expression is obtained.

$$Lb {2}_{k} = \frac{C 2 \cdot {R}_{ito}}{C 1} \cdot \frac{{La}_{max}}{Wa} - \frac{C 2}{C 2 - 1} ( \frac{C 2 \cdot {R}_{ito}}{C 1} \cdot \frac{{La}_{max}}{Wa} ) - {Lb}_{max} = \frac{{R}_{aux}}{{R}_{ito} + {R}_{aux}} \cdot \frac{Wb}{Wa} \cdot ( 1 + \frac{{R}_{aux}}{{R}_{ito}} ) \cdot {La}_{max} - \frac{{R}_{aux}}{{R}_{ito}} \cdot {Lb}_{max} \qquad [ Math 11 ]$$

By the way, when k=0, the value of Lb2ₖ at the outermost end of the wiring group, i.e., Lb2₍₁₎ is 0, and the value of Lb2ₖ is linearly changed from 0 to Lb2_{(n/2)}. Therefore, the length Lb2ₖ of the kth wiring after the trimming is expressed by either of the following equations:

$$\begin{matrix}Lb {2}_{k} = \frac{2 Lb {2}_{( n / 2 )}}{n} k , ( 0 \leq k \leq \frac{n}{2} ) & [ Math 12 ] \\ and & \\ Lb {2}_{k} = - \frac{2 Lb {2}_{( n / 2 )}}{n} k + 2 Lb {2}_{( n / 2 )} , ( \frac{n}{2} < k \leq n ) & [ Math 13 ]\end{matrix}$$

In this way, in the present embodiment, by determining the wiring length of the wiring pattern in the middle portion of the wiring group which extends from the scanning lines 21a in said connection part 21C, the operation of trimming the resistance value can be performed with ease.

In case where such an operation of trimming the resistance value is to be performed, the photomask for said wiring patterns in said segment B₂ can be prepared in accordance with the wiring pattern data which has been obtained using the above equations, and thus there is no need for an extra number of manufacturing steps.

For example, assuming that the above parameters are given as: Laₘₐₓ=10 mm, Lbₘₐₓ=5 mm, Wa=20 μm, Wb=20 μm, Rᵢₜₒ=10Ω/□, Rₐᵤₓ=2Ω/□, and n=100, the above equations give the value Lb1_{(n/2)}, Lb2_{(n/2)} of the wiring length in the middle portion (for the n/2th wiring pattern) in the segment B as Lb1_{(n/2)}=4 mm, Lb2_{(n/2)}=1 mm, and the synthesized sheet resistivity of Rᵢₜₒ and Rₐᵤₓ is calculated to be 1.67Ω/□, thus the wiring resistance in said segment B is found to be Rb1_{(n/2)}=1.67×4000/20=334Ω, Rb2_{(n/2)}=10×1000/20=500Ω.

Next, the deviation in resistance when a patterning error of ±1 μm has been caused in the present embodiment will be evaluated.

In case where, for the value of Lb1_{(n/2)}, Lb2_{(n/2)} that has been obtained as stated above, the Cr film 21a₂ is patterned shorter by 1 μm in said segment B₁, and Lb1_{(n/2)}=3.999 mm, Lb2_{(n/2)}=1.001 mm, the wiring resistance in said segment B is Rb1_{(n/2)}=1.67×3999/20=333.92Ω, Rb2_{(n/2)}=10×1001/20=500.5Ω, the deviation in resistance value is −0.05%. Likewise, in case where, in said segment B₁, the auxiliary wiring made up of said Cr film 21a₂ is patterned longer by 1 μm, and the wiring resistance in said segment B is Lb1_{(n/2)}=4001 mm, Lb2_{(n/2)}=0.999 mm, the deviation in resistance value is +0.05%.

In this way, according to the present invention, the accuracy can be improved by two digits by adjusting the wiring length, as compared to the accuracy which is achievable by the width adjustment.

### Second Embodiment

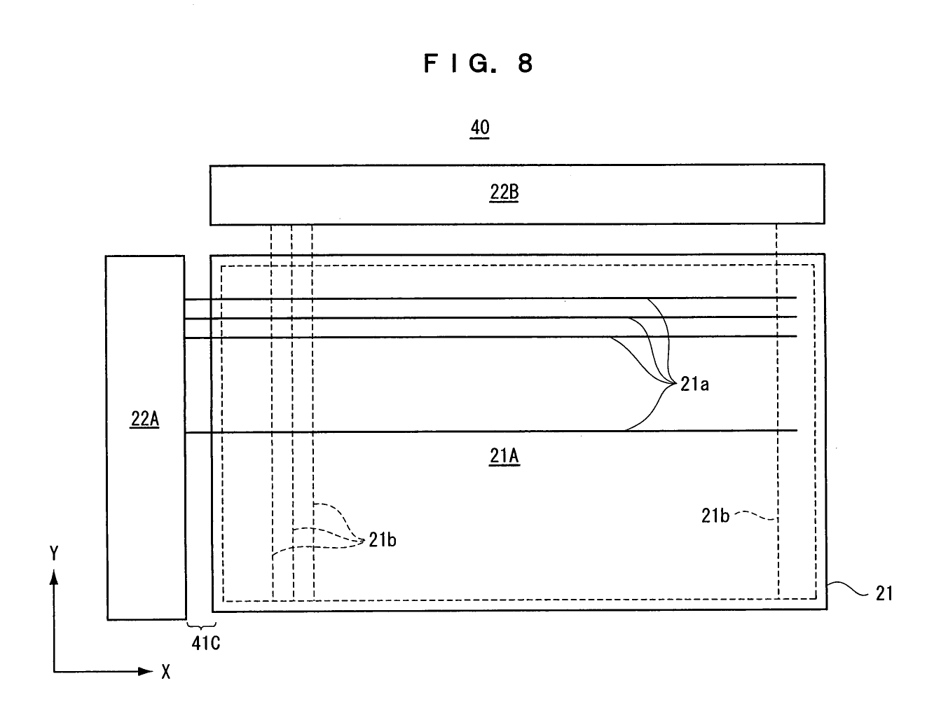

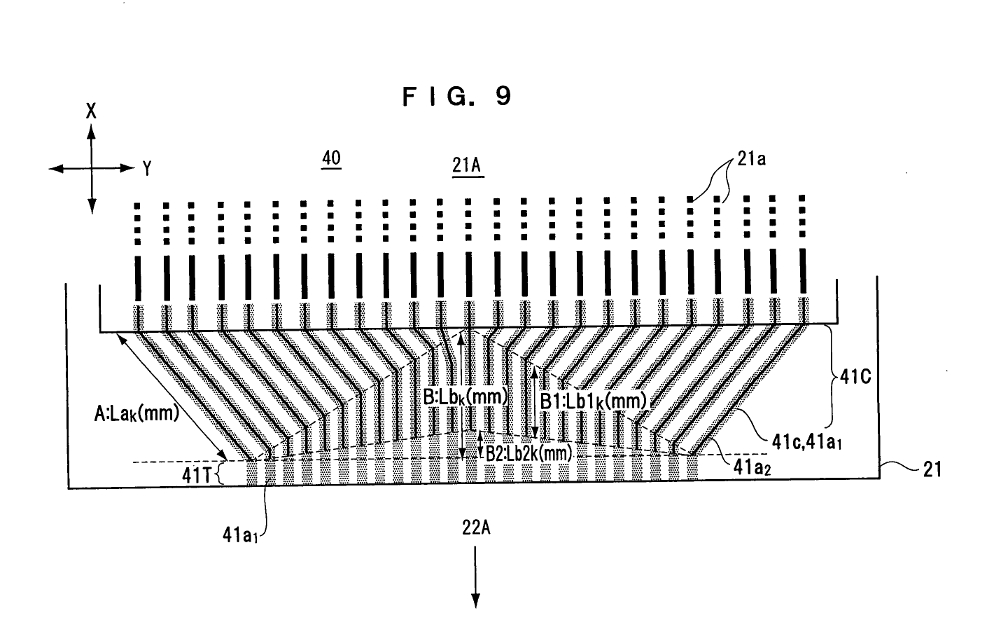

FIG. 8 shows a schematic configuration of an organic EL display apparatus 40 according to a second embodiment of the present invention, and FIG. 9 is a sectional view along the scanning electrodes in said display apparatus 40. In the figures, the portions corresponding to those which have been previously described are provided with the same reference signs, and explanation thereof is omitted.

Referring to FIG. 8, the display apparatus 40 is also a display apparatus of passive matrix drive type as with the display apparatus 20 in FIG. 4, however, in order to connect between said drive circuit 22A and said scanning lines 21a, a connection part 41C as shown in FIG. 9 is used in place of the connection part 21C in FIG. 6.

Referring to FIG. 9, said connection part 41C has substantially the same configuration as that of the connection part 21C in FIG. 6 on the top view, however, in place of the wiring patterns 21c which are constituted by the extending portions of said scanning lines 21c, it comprises wiring patterns 41c which are connected to the ends of said scanning lines 21a and are converged to a terminal part 41T which is formed in correspondence to the terminals of said drive circuit 22A.

Said wiring pattern 41c is divided into the segment A and the segment B along the extending direction therefor as with said wiring pattern 21c, and the segment length Laₖ of the segment A is at maximum with the wiring pattern 41c which corresponds to the scanning line 41a in the outermost portion, while it is zero with the wiring pattern 41c which corresponds to the scanning line 41a in the middle portion.

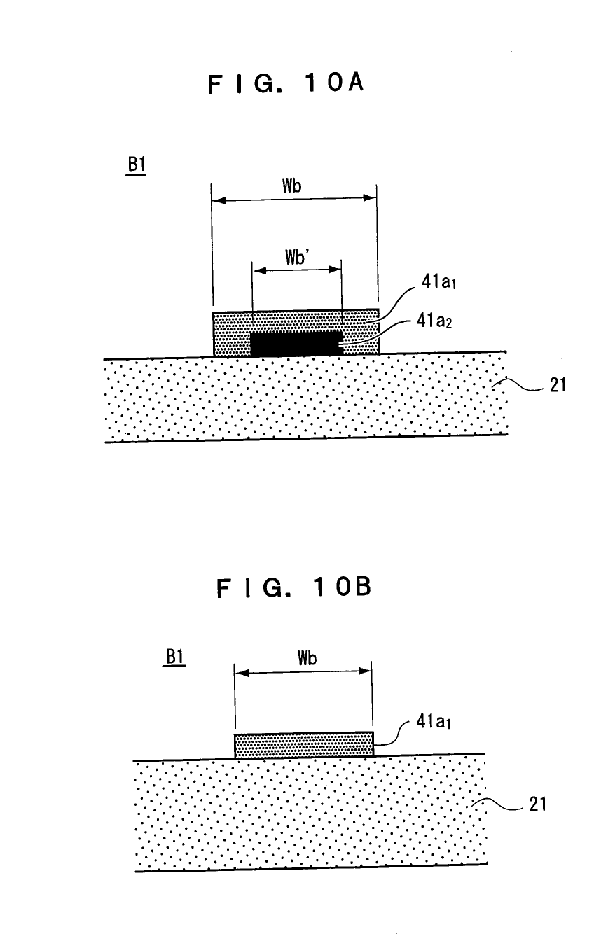

In addition, said segment B is divided into the segments B₁ and B₂, and in the segment B₁, the wiring pattern 41c has the same lamination structure as that of the scanning line 41a, of an ITO film 41a, and a silver alloy film 41a₂, as shown in FIG. 10A, while, in said segment B₂, the wiring pattern 41c is constituted only by the ITO film 41a, as shown in FIG. 10B. The ITO patterns 41a₁ in the segment B₂ are further extended to constitute said terminal part 41T where they are compression bonded to the electrodes of the drive circuit 22A.

Also in the present embodiment, as in the previous embodiment, the segment length Lb1ₖ in said segment B₁ of said wiring pattern 41c is trimmed, whereby, in said connection part 41C, the mutual difference in resistance value produced between scanning lines 41a is eliminated.

As said silver alloy, an alloy of silver and palladium or copper is used, whereby a sheet resistivity further lower than that of the Cr alloy can be realized. On the other hand, because the silver alloy tends to cause degradation in properties due to electromigration or oxidation, compared to the Cr alloy, thus as shown in FIG. 10A, said silver alloy film 41a₂ is formed in said segment B1 such that it is protected by said ITO film 41a₁ and said glass substrate 21, being placed under said ITO film 41a, and on said glass substrate 21.

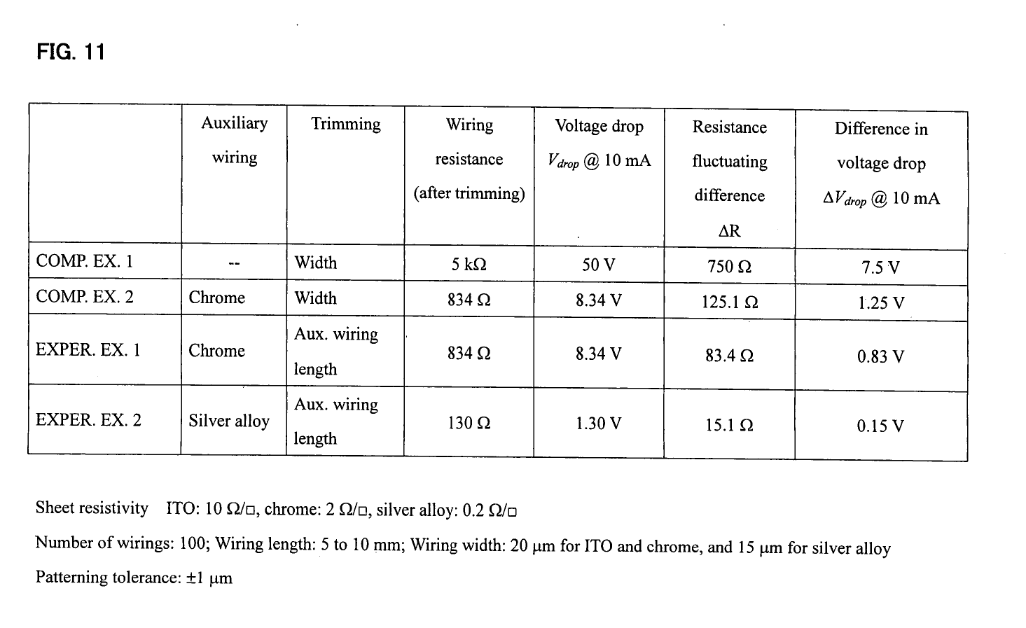

Hereinbelow, trimming to be performed on the connection part 11C in FIG. 11 will be described in detail.

As previously described, with the wiring pattern 41c which corresponds to the scanning line 41a in the middle portion, the wiring length La in said segment A is zero, while this wiring length La is linearly increased in proportion to the distance from said middle portion with the scanning line 41a on the outer side.

Then, assuming that the length of the wiring pattern 41c at the outermost end is Laₘₐₓ (mm), the wiring length Laₖ of the wiring pattern 41c of kth from the middle portion (k=0) in said segment A is expressed by either of the following equations:

$$\begin{matrix}{La}_{k} = - \frac{2 {La}_{max}}{n} k + {La}_{max} , ( 0 \leq k \leq \frac{n}{2} ) & [ Math 14 ] \\ \text{and} & \\ {La}_{k} = \frac{2 {La}_{max}}{n} k - {La}_{max} , ( \frac{n}{2} < k \leq n ) & [ Math 15 ]\end{matrix}$$

On the other hand, the length Lb (mm) of said wiring pattern 41c in said segment B is also linearly changed from the substrate middle portion toward the outside, and is at maximum with the wiring pattern 41c which corresponds to the scanning line 41a in the middle portion, while being zero at the outermost end. Then, assuming that the segment length Lb in said middle portion is Lbₘₐₓ, the wiring length Lbₖ of kth from the middle portion is expressed by either of the following equations:

$$\begin{matrix}{Lb}_{k} = \frac{2 {Kb}_{max}}{n} k , ( 0 \leq k \leq \frac{n}{2} ) & [ Math 16 ] \\ \text{and} & \\ {Lb}_{k} = - \frac{2 {Lb}_{max}}{n} k + 2 {Lb}_{max} , ( \frac{n}{2} < k \leq n ) & [ Math 17 ]\end{matrix}$$

Herein, assuming that the sheet resistivity of said ITO film 41a₁ is Rᵢₜₒ (Ω/□); the sheet resistivity of the silver alloy film 41a₂ is Rₐᵤₓ (Ω/□); the width of said ITO film 41a₁, i.e., the width of the wiring pattern 41c in the segment A is Wa; the width of the silver alloy film 41a₂ in the segment A is Wa′; the width of the said ITO film 41a₁, i.e., the width of the wiring pattern 41c in the segment B is Wb; and the width of the silver alloy film 41a₂ in the segment B is Wb′, the wiring resistances Raₖ, Rbₖ in the segment A and B are expressed by the following equations, respectively.

$$Ra = \frac{{R}_{ito} \cdot {R}_{aux}}{{R}_{ito} \frac{{Wa}^{′}}{Wa} + {R}_{aux}} \cdot \frac{{La}_{k}}{Wa} \\ {Rb}_{k} = \frac{{R}_{ito}}{Wb} ( \frac{{R}_{aux}}{{R}_{ito} \cdot \frac{{Wb}^{′}}{Wb} + {R}_{aux}} Lb {1}_{k} + Lb {2}_{k} ) \qquad [ Math 18 ]$$

And, the resistance Rₖ of the kth wiring pattern 41c in said connection part 41T is expressed by the equation: Rₖ=Raₖ+Rbₖ

Here, Lb1ₖ and Lb2ₖ express the wiring length of said wiring pattern 41c in said segment B₁ and B₂, respectively.

Next, the procedure for trimming said wiring length Lb1ₖ, Lb2ₖ will be described.

As in the previous embodiment, the purpose of trimming is to set said resistance Rₖ at the same value for all the patterns. Hereinbelow, for simplicity, the case where 0≦k≦n/2 will be handled.

Considering the wiring pattern 41c at k=n/2, i.e., that in the middle portion, the length Lb2ₖ thereof, i.e., Lb2_{(n/2)} is expressed by the following equation from the relational expression Lb1ₖ+Lb2ₖ=Lbₘₐₓ.

$$Lb {2}_{( n / 2 )} = \frac{{R}_{aux} \cdot Wb}{{R}_{ito} \cdot {Wb}^{′} + {R}_{aux} \cdot Wa} \cdot ( 1 + \frac{{R}_{aux}}{{R}_{ito}} \cdot \frac{Wb}{{Wb}^{′}} ) \cdot {La}_{max} - \frac{{R}_{aux}}{{R}_{ito}} \cdot \frac{Wb}{{Wb}^{′}} \cdot {Lb}_{max} \qquad [ Math 19 ]$$

In case where k=n/2, in the above relational expression:

$${Rb}_{k} = \frac{{R}_{ito}}{Wb} ( \frac{{R}_{aux}}{{R}_{ito} \cdot \frac{{Wb}^{′}}{Wb} + {R}_{aux}} Lb {1}_{k} + Lb {2}_{k} ) \qquad [ Math 20 ]$$

assuming that:

$$C 1 = \frac{{R}_{ito}}{Wb} \\ C 2 = \frac{{R}_{aux}}{{R}_{ito} \cdot \frac{{Wb}^{′}}{Wb} \cdot {R}_{aux}} \qquad [ Math 21 ]$$

the following equations are given.

$$\begin{matrix}{Rb}_{k} = C 1 ( C 2 \cdot Lb {1}_{k} + Lb {2}_{k} ) & \\ Lb {2}_{k} = \frac{{Rb}_{k}}{C 1} - C 2 \cdot Lb {1}_{k} = {Lb}_{max} - Lb {1}_{k} \\ Lb {1}_{k} = \frac{1}{C 2 - 1} ( \frac{{Rb}_{( n / 2 )}}{C 1} - {Lb}_{max} ) \\ Lb {2}_{k} = \frac{{Rb}_{( n / 2 )}}{C 1} - C 2 \cdot Lb {1}_{k} = \frac{{Rb}_{( n / 2 )}}{C 1} - \frac{C 2}{C 2 - 1} ( \frac{{Rb}_{( n / 2 )}}{C 1} - {Lb}_{max} ) & [ Math 22 ]\end{matrix}$$

Here, assuming that

$$C 3 = \frac{{R}_{aux}}{{R}_{ito} \cdot \frac{{Wa}^{′}}{Wa} + {R}_{aux}} \qquad [ Math 23 ]$$

the resistance Raₖ is expressed by the following equation:

$${Ra}_{k} = C 3 \cdot {R}_{ito} \cdot \frac{{La}_{k}}{Wa} \qquad [ Math 24 ]$$

However, from the requirement that, after the trimming, all the wiring patterns 41c must be equal in resistance, the value of the 0th Raₖ, i.e., Ra₍₀₎ must be equal to that of the n/2th Rbₖ, i.e., Rb_{(n/2)}.

Therefore, the following relational expression is obtained.

$${Rb}_{( n / 2 )} = {Ra}_{( 0 )} = C 3 \frac{{La}_{max}}{Wa} \cdot {R}_{ito} \qquad [ Math 25 ]$$

From this, the following relational expression is obtained.

$$\begin{matrix}Lb {2}_{k} = \frac{C 3 \cdot {R}_{ito}}{C 1} \cdot \frac{{La}_{max}}{Wa} - \frac{C 2}{C 2 - 1} ( \frac{C 3 \cdot {R}_{ito}}{ C 1} \cdot \frac{ {La}_{max}}{ Wa} - {Lb}_{max} ) \\ = \frac{{R}_{aux}}{{R}_{ito} \cdot \frac{{Wa}^{′}}{Wa} + {R}_{aux}} \cdot \frac{Wb}{Wa} \cdot ( 1 + \frac{{R}_{aux}}{{R}_{ito}} \cdot \frac{Wb}{{Wb}^{′}} ) \cdot {La}_{max} - \frac{{R}_{aux}}{{R}_{ito}} \cdot \frac{Wb}{{Wb}^{′}} \cdot {Lb}_{max} & [ Math 26 ]\end{matrix}$$

Then, the above relational expression is obtained.

On the other hand, considering the wiring pattern 41c at k=0, i.e., the outermost end, the length Lb2ₖ, i.e., Lb2₍₀₎ is zero, and the value of Lb2ₖ is linearly changed from zero to Lb2_{(n/2)}.

Therefore, the length of the kth wiring after the trimming is expressed by either of the following equations:

$$\begin{matrix}Lb {2}_{k} = \frac{2 Lb {2}_{( n / 2 )}}{n} , ( 0 \leq k \leq \frac{n}{2} ) \\ and \\ & [ Math 27 ] \\ Lb {2}_{k} = - \frac{2 Lb {2}_{( n / 2 )}}{n} k + 2 Lb {2}_{( n / 2 )} , ( \frac{n}{2} < k \leq n ) & [ Math 28 ]\end{matrix}$$

Herein, assuming that the above parameters are given as: Laₘₐₓ=10 mm, Lbₘₐₓ=5 mm, Wa=20 μm, Wb=20 μm, Wa′=15 μm, Wb′=15 μm, Rᵢₜₒ=10Ω/□, Rₘₐₓ=0.2Ω/□, and n=100, said wiring length is calculated to be:
Lb1_{(n/2)}=4.867 (mm), Lb2_{(n/2)}=0.133 (mm).

Further, the synthesized sheet resistivity of Rᵢₜₒ and Rₐᵤₓ is calculated to be 0.196Ω/□, thus the wiring resistance for the wiring pattern 41c in said segment B is found to be:
Rb1_{(n/2)}=0.260×4897/20=63.21Ω,
Rb2_{(n/2)}=10×133/20=66.5Ω,

Next, the influence of a patterning error on the trimming in the present embodiment will be evaluated.

Assuming that the above-mentioned ideal wiring length Lb1_{(n/2)}, Lb1_{(n/2)} has had a patterning error of −1 μm, the actual wiring length would be Lb1_{(n/2)}=3.999 (mm), Lb1_{(n/2)}=1.001 (mm), and in this case, the resistance would be:
Rb1_{(n/2)}=0.260×4866/20=63.26Ω,
Rb2_{(n/2)}=10×134/20=67Ω,
thus a deviation in resistance of −0.5% is expected to be caused.

Likewise, assuming that the above-mentioned ideal wiring length Lb1_{(n/2)}, Lb1_{(n/2)} has had a patterning error of +1 μm, the actual wiring length would be Lb1_{(n/2)}=4.001 (mm), Lb1_{(n/2)}=0.999 (mm), and in this case, a deviation in resistance of +0.5% is expected to be caused.

In this way, also in trimming in the present embodiment, the trimming accuracy as high as ten times or over can be achieved, as compared to the accuracy which is achievable by adjusting the pattern width for trimming.

FIG. 11 gives the results of measurement or computation of the wiring resistance and the voltage drop caused thereby; further the difference, ΔR, between the maximum and minimum values of said wiring resistance; and the difference, ΔV, between the maximum and minimum values of the voltage drop caused by said ΔR for the entire scanning line 21a or 41a that were obtained when the trimming was performed according to said embodiment 1 and 2 in EXPERIMENTAL EXAMPLEs 1 and 2, and COMPARATIVE EXAMPLEs 1 and 2. In COMPARATIVE EXAMPLE 1, no auxiliary wiring made up of a Cr film, a silver alloy film, or the like, was provided, and the trimming of the resistance value was performed by adjusting the width of the wiring pattern 11c. In addition, in COMPARATIVE EXAMPLE 2, as an auxiliary wiring, a Cr film was provided, however, the trimming of the resistance value was performed by adjusting the width of the wiring pattern 21c. Contrarily to this, EXPERIMENTAL EXAMPLE 1 corresponds to the previously described embodiment 1, and the trimming was performed by adjusting the wiring length of the auxiliary wiring, in other words, the Cr pattern 21a₂ in the segment B₁ in FIG. 6. In addition, EXPERIMENTAL EXAMPLE 2 corresponds to the previously described embodiment 2, and the trimming was performed by adjusting the wiring length of the auxiliary wiring, in other words, the Ag alloy pattern 41a₂ in the segment B₁ in FIG. 11.

Referring to FIG. 11, it can be seen that, in COMPARATIVE EXAMPLEs, the fluctuating difference in resistance value, ΔR, attained 750Ω or 125.1Ω, and in correspondence thereto, the difference in voltage drop, ΔV_{drop}, also attained 7.5 V or 1.25 V when a drive current of 10 mA was caused to flow. Contrarily to this, in the present invention, the fluctuating difference in resistance value, ΔR, for the wiring pattern 21c or 41c that was caused by the difference in wiring length of the connection part 21c or 41c was reduced to 83.4Ω in EXPERIMENTAL EXAMPLE 1, and to 15.1Ω in EXPERIMENTAL EXAMPLE 2, and together with this, the difference in voltage drop, ΔV_{drop}, was also reduced to 0.83 V in EXPERIMENTAL EXAMPLE 1, and to 0.15 V in EXPERIMENTAL EXAMPLE 2.

In the above description, the case where, in said segments B₁ and B₂, the wiring length Lb1ₖ and the wiring length Lb2ₖ are linearly changed with the number k has been considered, however, when trimming is performed on the wiring length as with the present invention, occurrence of a slight patterning error has no significant influence on the fluctuating difference in resistance value as can be seen from FIG. 11, thus the wiring length Lb1ₖ in the segment B₁ and the wiring length Lb2ₖ in the segment B₂ may be changed stepwise or arcwise as shown in FIG. 12, for example. In FIG. 12, the portions corresponding to those which have been previously described are provided with the same reference signs, and explanation thereof is omitted.

The connection part 21C or 41C in FIG. 6 or 11 may be provided for the connection part between the data electrodes 21b and the drive circuit 22B as required.

### Third Embodiment

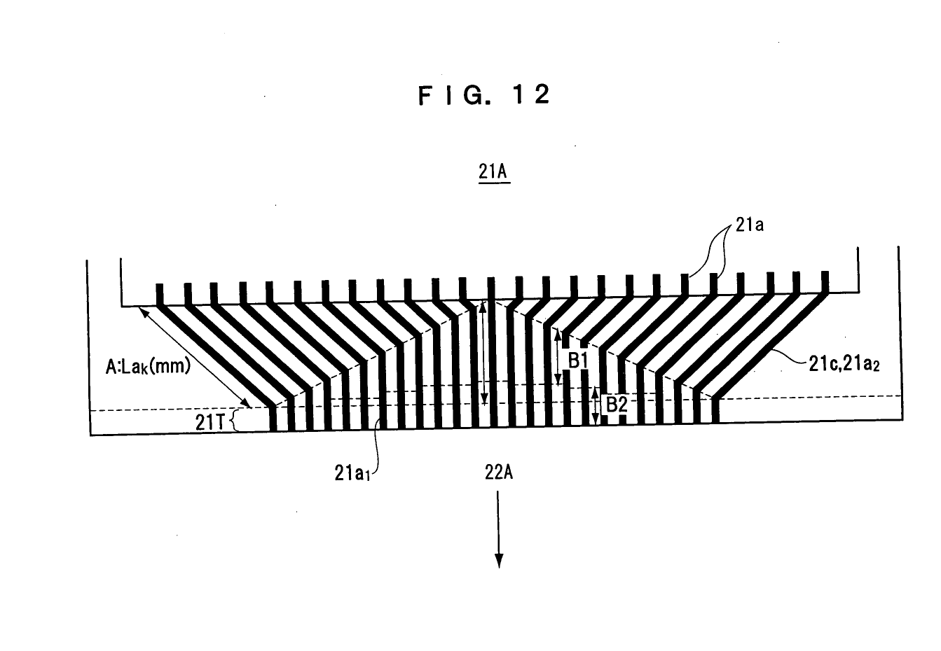

FIG. 13 shows a part of the configuration of an organic EL display apparatus of passive matrix drive type according to a third embodiment of the present invention. In FIG. 13, the portions corresponding to those which have been previously described are provided with the same reference signs, and explanation thereof is omitted.

FIG. 13 is a sectional view of a wiring pattern 21c in the segment B, that is the same as that as shown in FIG. 7A, which has been previously described, except that the location of said ITO pattern 21a₁ and that of the lower resistance pattern 21a₂ are mutually displaced. The organic EL display apparatus of passive matrix drive type according to the present embodiment is a modification of the organic EL display apparatus 20 as previously described in FIG. 6, having substantially the same configuration.

Also in such a case, by removing said Cr film 21a₂ with a lower resistance in said terminal part 21T, only the ITO pattern 21a₁ is exposed, and the same sectional configuration as that in FIG. 7B is obtained. Therefore, also in the present embodiment, good compression bonding to the flexible substrate through the ITO patterns can be realized.

### Fourth Embodiment

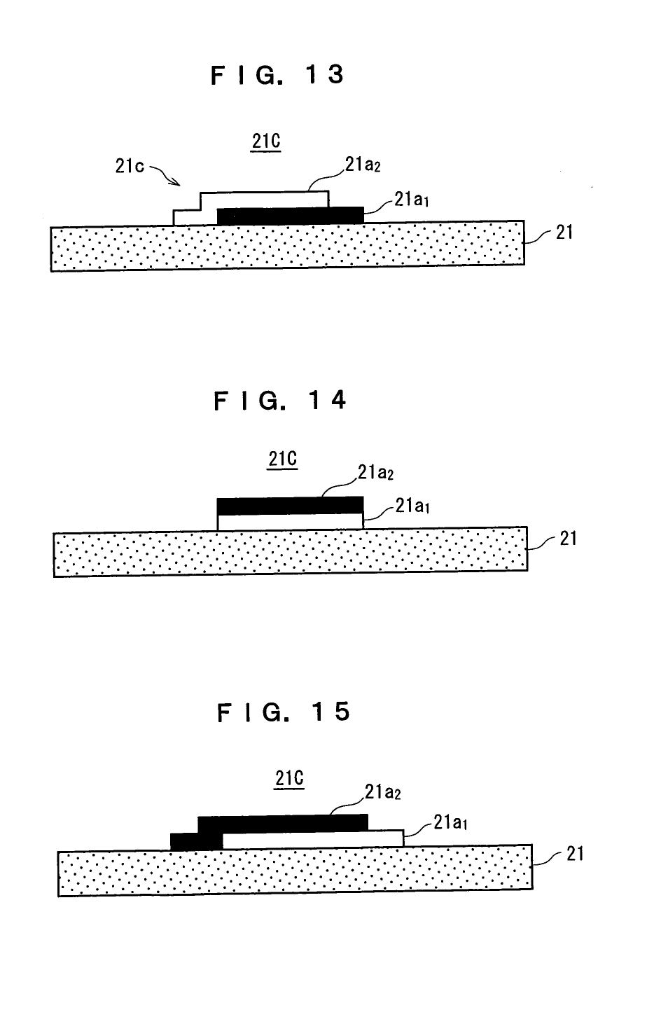

FIG. 14 shows a part of the configuration of an organic EL display apparatus of passive matrix drive type according to a fourth embodiment of the present invention. In FIG. 14, the portions corresponding to those which have been previously described are provided with the same reference signs, and explanation thereof is omitted.

FIG. 14 is a sectional view of a wiring pattern 21c in the segment B₁ that is the same as that as shown in FIG. 7A, which has been previously described, except that the vertical location of said ITO pattern 21a₁ and that of the lower resistance pattern 21a₂ are replaced with each other, in other words, said Cr pattern 21a₂ provides a lower pattern, while the ITO pattern 21a₁ provides a lower pattern. The organic EL display apparatus of passive matrix drive type according to the present embodiment is a modification of the organic EL display apparatus 20 as previously described in FIG. 6, having substantially the same configuration.

Also in such a case, by removing said Cr film 21a₂ with a lower resistance in said terminal part 21T, only the ITO pattern 21a₁ is exposed, and the same sectional structure as that in FIG. 7B is obtained. Therefore, also in the present embodiment, good compression bonding to the flexible substrate through the ITO patterns can be realized.

FIG. 15 shows a further modification of the wiring pattern 21c as shown in FIG. 14 with which the positional relationship between the upper ITO pattern 21a₁ and the lower Cr pattern 21a₂ in FIG. 14 is reversed.

Also in such a case, by removing said Cr film 21a₂ with a lower resistance in said terminal part 21T, only the ITO pattern 21a₁ is exposed, and the same sectional structure as that in FIG. 7B is obtained. Therefore, also in the present embodiment, good compression bonding to the flexible substrate through the ITO patterns can be realized.

### Fifth Embodiment

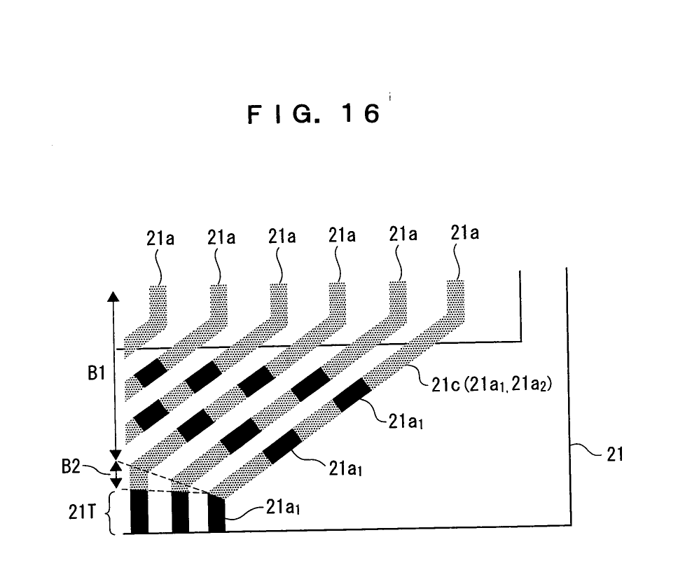

FIG. 16 shows a part of the configuration of an organic EL display apparatus of passive matrix drive type according to a fifth embodiment of the present invention. In FIG. 16, the portions corresponding to those which have been previously described are provided with the same reference signs, and explanation thereof is omitted.

Referring to FIG. 16, in the present embodiment, the Cr pattern 21a₂ with a lower resistance that is formed on said ITO pattern 21a₁ in said segment B₁ is removed in one place or a plurality of places, whereby a higher resistance is provided in that portion or those portions.

Then, by providing such a higher resistance portion(s) for the respective wiring patterns 21c according to the location of the corresponding scanning line 21a, in other words, by adjusting the number of higher resistance portions or the length thereof, the resistance value for said wiring pattern 21c can be adjusted according to the corresponding scanning line 21a.

Further, the present invention is applicable not only to the organic EL display apparatus, but also to any other display apparatuses of current drive type that are passive matrix driven, for example, plasma display panels (PDP), LED array display apparatuses, light sources, and the like.

Further, the present invention is applicable not only to the display apparatus of current drive type, but also to liquid crystal display apparatuses of passive matrix drive type or active matrix drive type.

### INDUSTRIAL APPLICABILITY

According to the present invention, in the connection part where the drive electrodes extending in the display region of the display apparatus are converged to be connected to the drive circuit, the length of the auxiliary electrode is changed according to the length of the wiring pattern in such connection part, whereby the difference in resistance, i.e., the difference in amount of voltage drop produced between different wiring patterns in the connection part can be set at a constant value regardless of the location of the wiring pattern, and thus the display apparatus can be uniformly driven.

1. A display apparatus, comprising:
a substrate;
a first electrode group made up of a plurality of electrode patterns which are arranged adjacent to one another on the substrate, and extend in a first direction;
a second electrode group made up of a plurality of electrode patterns which are arranged adjacent to one another on the substrate, and extend in a second direction which is different from the first direction; and
a plurality of display elements which are each formed in correspondence to an intersection point of one electrode pattern among the first electrode group and one electrode pattern among the second electrode group,
wherein
at least the first electrode group includes a plurality of electrode patterns which are each connected to a drive circuit at one end, and are different in length from the one end to the other end,
each of the plurality of electrode patterns has a lamination structure which has a first conductor having a first sheet resistivity, and a second conductor having a second sheet resistivity lower than the first sheet resistivity,
each of the plurality of electrode patterns is provided with a higher resistance region where the second conductor is removed, and
the length of the higher resistance region is changed according to the length of the electrode pattern for each of said plurality of electrode patterns,
wherein,
on the substrate, a display region where the plurality of electrode patterns extend in parallel with one another at a first spacing, a terminal region where the one ends of the plurality of electrode patterns in the display region are arranged at a second smaller spacing, and a connection part where the plurality of electrode patterns in the display region are respectively connected to the corresponding one ends in the terminal region are provided, and in each of the electrode patterns in the connection region, the second conductor is removed at a plurality of places.

2. The display apparatus of claim 1, wherein, in the plurality of electrode patterns, the length of the higher resistance region is reduced with the length of the electrode pattern.

3. The display apparatus of claim 1, wherein the plurality of electrode patterns have substantially the same resistivity value from the one end to the other end.

4. The display apparatus of claim 1, wherein, on the substrate, a display region where the plurality of electrode patterns extend in parallel with one another at a first spacing, a terminal region where the one ends of said plurality of electrode patterns in the display region are arranged at a second smaller spacing, and a connection part where the plurality of electrode patterns in the display region are respectively connected to the corresponding one ends in the terminal region are provided, in the terminal region, in each of the electrode patterns, the second conductor is removed, and the higher resistance region is formed such that it is continued to the terminal region in the connection region.

5. The display apparatus of claim 4, wherein, in the display region, the plurality of electrode patterns constituting the first electrode group are repetitively formed in the second direction, among the plurality of electrode patterns, the length of the electrode pattern in the middle is the shortest, and the length of the electrode pattern is symmetrically increased from the electrode pattern in the middle toward both outside directions.

6. The display apparatus of claim 5, wherein, in the connection region, the plurality of electrode patterns extend while maintaining the parallel relationship.

7. The display apparatus of claim 5, wherein the higher resistance region has the greatest length at the electrode pattern in the middle, and the length of the higher resistance region is symmetrically reduced from the electrode pattern in the middle toward both outside directions.

8. The display apparatus of claim 7, wherein the length of the higher resistance region is linearly reduced from the electrode pattern in the middle toward both outside directions according to the distance from the electrode pattern in the middle.

9. The display apparatus of claim 7, wherein the length of the higher resistance region is stepwise reduced from the electrode pattern in the middle toward both outside directions according to the distance from the electrode pattern in the middle.

10. The display apparatus of claim 1, wherein the first conductor is made up of a transparent oxide electrode material, and the second conductor is made up of a metallic material.

11. The display apparatus of claim 1, wherein the second conductor is laminated on the first conductor.

12. The display apparatus of claim 1, wherein the second conductor is embedded in the first conductor.

13. The display apparatus of claim 1, wherein an electrode pattern in the second electrode group is connected to another drive circuit, and an electrode pattern in the first electrode group forms, with the electrode pattern in the second electrode group, a current path for the drive current flowing in a display element which is formed at the intersection point.

14. The display apparatus of claim 1, wherein the display element is an organic EL display apparatus.

15. The display apparatus of claim 11, wherein the second conductor is formed such that it partially overlaps the first conductor in the direction along the width of the electrode pattern.

16. The display apparatus of claim 1, wherein the first conductor is laminated on the second conductor.

17. The display apparatus of claim 16, wherein the second conductor is formed such that it partially overlaps the first conductor in the direction along the width of the electrode pattern.

18. (canceled)
